(19) United States
(12) Patent Application Publication
(10) Pub. No.: US 2012/0306661 A1
(43) Pub. Date: Dec. 6, 2012

(54) Apparatus for Smart Home Network

(75) Inventors: Fei Xue, Beijing (CN); Xianzhang Lei, Chengdu (CN); Yebiao Zhang, Beijing (CN); Hongchao Liu, Beijing (CN); Sheng Zhang, Beijing (CN)

(73) Assignees: State Grid Corporation of China (SGCC), Beijing (CN); China Electric Power Equipment and Technology Co. Ltd., Beijing (CN)

(21) Appl. No.: 13/472,291

(22) Filed: May 15, 2012

(30) Foreign Application Priority Data
May 31, 2011 (CN) 201110144565.3

(51) Int. Cl. G08C 15/06

(52) U.S. Cl. 340/870.02

(57) ABSTRACT

A smart home network comprises a plurality of appliances, each of which comprises a unique radio frequency identification tag. The smart home network further comprises a plurality of power outlets, each of which has a unique ID. The power outlets of the smart home network are capable of detecting the RFID tag and measuring the operational parameters of the appliances. The power outlets are further coupled to a central controller. The central controller receives operational parameters of the appliances from the power outlets, constructs a real time model of the smart home and forwards analytical results to a display terminal.

This application claims priority to Chinese Application No. 201110144565.3, filed on May 31, 2011, which is incorporated herein by reference in its entirety.

### BACKGROUND

A modern home may comprise a plurality of appliances such as televisions, refrigerators, microwave ovens, dish-washers, air conditioners, media players, vacuums and the like. Depending on the physical characteristics of home appliances, the appliances of a modern home may be divided into three categories, namely fixed appliances, semi-fixed appliances and portable appliances. The fixed appliances may comprise some appliances installed in fixtures attached to fixed structures. The semi-fixed appliances may comprise some appliances unlikely to be moved due to their heavy weights. The portable appliances may include some portable devices such as portable vacuums, media players and the like.

The majority of home appliances may require a power plug in order to get electricity from the utility system. In particular, a power outlet is coupled to the utility system and fixed on a building structure. The power plug of an appliance is plugged into the power outlet. As a result, power from the utility system can sustain the operation of the appliance.

Radio frequency identification (RFID) devices may be employed to identify different appliances so that the various types of appliances of a modern home can be wirelessly coupled together through a central hub, which functions as a brain of the modern home. A RFID system may comprise a RFID tag attached to an object to be identified and a RFID reader comprising a transceiver through which the RFID reader sends a radio frequency signal targeting the RFID tag and receives the response from the RFID tag. The RFID tag may be passive or active. If the RFID tag is passive, the read range of the RFID reader is limited. In other words, in order to be reliably identified, the object, to which the passive RFID tag is attached, must be placed in a certain degree of proximity of the RFID reader. On the other hand, if the RFID tag is active, the active RFID tag can periodically transmit its identification to the RFID reader. As a result, the read range of the active RFID tag is much larger in comparison with that of the passive RFID tag.

After RFID devices are employed to identify appliances of a smart home, each appliance of the smart home becomes a unique entity in the smart home. In addition, each appliance may be coupled to a central hub as well as other appliances through wire or wireless channels so that the appliances of the smart home can communicate with each other. As a result, the appliances of the smart home form a network. Such a network comprising a plurality of identified objects is commonly known as Internet of Things.

### SUMMARY OF THE INVENTION

These and other problems are generally solved or circumvented, and technical advantages are generally achieved, by preferred embodiments of the present invention which provide an apparatus for identifying each appliance of a smart home and retrieving the operational parameters of the appliances of the smart home.

In accordance with an embodiment, an apparatus comprises a location mapping unit coupled between a power outlet and an outlet location unit, wherein the location mapping unit links an outlet identification number of the power outlet with a location of a smart home, an appliance mapping unit coupled between a reader and an appliance identification unit, wherein the appliance mapping unit links an appliance identification number of an appliance with various system parameters of the appliance, a measurement unit configured to measure operational parameters of the appliance and an information storage and analysis unit coupled to the outlet location unit and the measurement unit.

The information storage and analysis unit is configured to receive the various system parameters of the appliance, the location and the operational parameters of the appliance, analyze the various system parameters of the appliance and the operational parameters of the appliance; and send operational information of the appliance to an input and output device.

In accordance with another embodiment, a system comprises an appliance comprising a power plug and a radio frequency identification tag attached to the power plug, a power outlet comprising a reader configured to send a radio frequency signal to the radio frequency identification tag and receive a response from the radio frequency identification tag.

The power outlet further comprises an outlet identification unit coupled to a network hub, wherein a location identification and its corresponding outlet identification are forwarded from the outlet identification unit to the network hub and a measurement unit coupled to a power cable attached to the power outlet, wherein the measurement unit is configured to measure operational parameters of the power outlet. The system further comprises an information storage and analysis unit coupled to the reader, the outlet identification unit and the measurement unit and a display terminal coupled to the information storage and analysis unit.

In accordance with yet another embodiment, a method comprises sending a radio frequency signal to a radio frequency identification tag, wherein the radio frequency identification tag is attached to a power plug of an appliance, receiving a response from the radio frequency identification tag, measuring operational parameters of a power outlet, wherein the power plug is plugged into the power outlet, forwarding the operational parameters of the power outlet, an identification number of the power outlet, the response from the radio frequency identification tag to an information storage and analysis unit through a network hub and displaying a plurality of parameters of the appliance through an input and output device.

An advantage of an embodiment of the present invention is that each appliance of a smart home can be identified through a unique identification number. In addition, the operational parameters of the appliance can be retrieved through a measurement unit of a power outlet and sent to an information storage and analysis unit. As a result, a user can access the operational parameters of the smart home through a display terminal coupled to the information storage and analysis unit.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a simplified diagram of a smart home in accordance with an embodiment;

FIG. 2 illustrates a simplified diagram of a smart appliance in accordance with an embodiment; and

FIG. 3 illustrates a block diagram of a central controller in accordance with an embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments of the disclosure, and do not limit the scope of the disclosure.

The present disclosure will be described with respect to embodiments in a specific context, an apparatus and system for a smart home including a variety of appliances. The embodiments of the disclosure may also be applied, however, to a variety of residential and industrial applications. Hereinafter, various embodiments will be explained in detail with reference to the accompanying drawings.

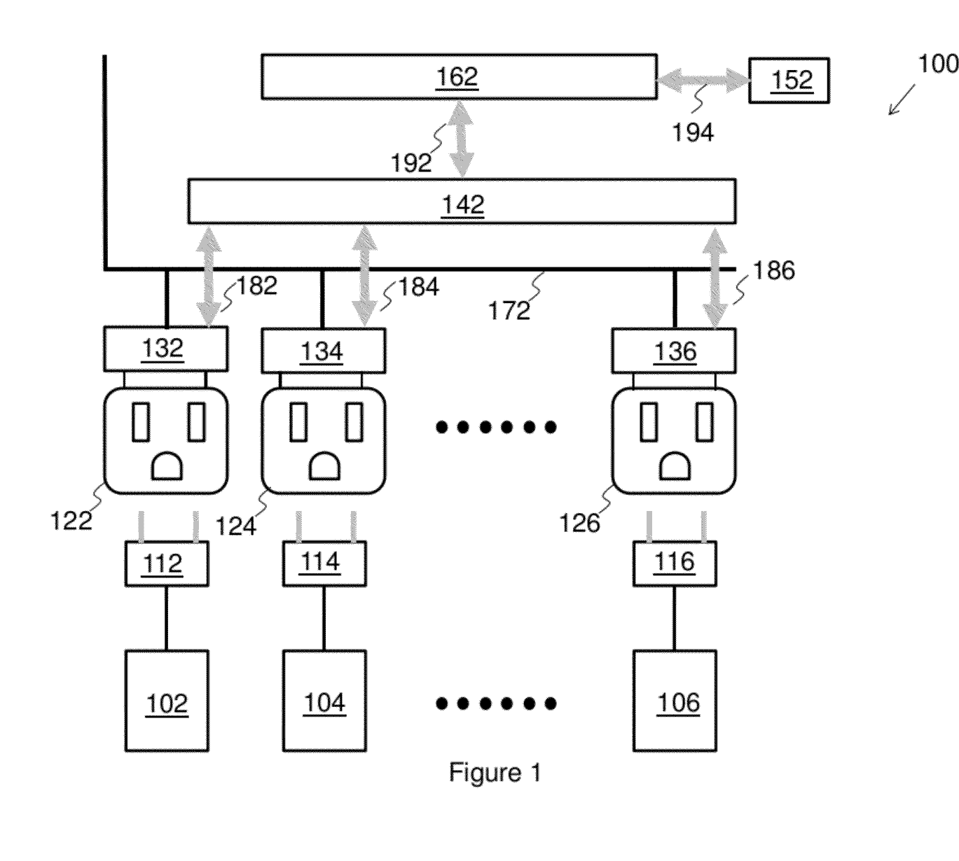

FIG. 1 illustrates a simplified diagram of a smart home in accordance with an embodiment. The smart home 100 may comprise a plurality of appliances, namely a first appliance 102, a second appliance 104 and a third appliance 106. In accordance with an embodiment, the first appliance 102 may be a refrigerator; the second appliance 104 may be a television; the third appliance 106 may be a water heater. It should be recognized that while FIG. 1 illustrates the smart home 100 with three appliances, the smart home 100 could accommodate any number of appliances.

The appliances (e.g., the first appliance 102) are of a power plug. As shown in FIG. 1, the first appliance 102 is of a first plug 112; the second appliance 104 is of a second plug 114; the third appliance 106 is of a third plug 116. The plugs (e.g., the first plug 112) are of the common features of a traditional power plug. In addition, each power plug may comprise a RFID tag (not shown). The RFID tag may be attached to the exterior surface of the power plug. Alternatively, the RFID tag may be embedded inside the power plug.

The smart home 100 may further comprise a plurality of power outlets installed in various locations of the smart home 100. As shown in FIG. 1, a first power outlet 122 is installed in a first location 132; a second power outlet 124 is installed in a second location 134; a third power outlet 136 is installed in a third location 136. It should be noted while three power outlets are included in FIG. 1, the smart home 100 may employ multiple power outlets installed in a number of locations. A person skilled in the art will recognize that three power outlets and three locations are illustrated for simplicity.

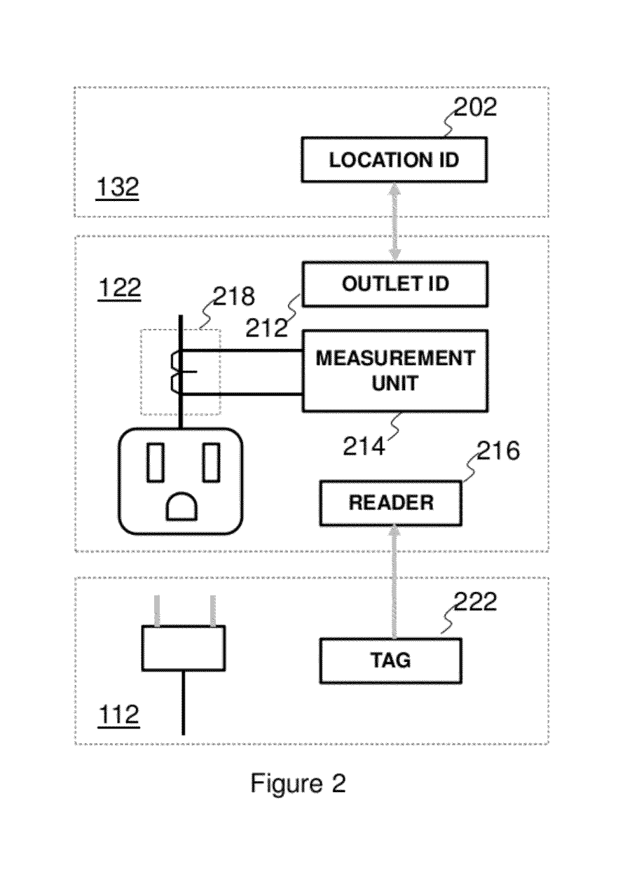

It should further be noted that a power outlet and its corresponding location are not fixed. In response to the needs of the smart home 100, a power outlet can be installed in any locations of the smart home 100. A central control system of the smart home 100 is capable of detecting the location of a power outlet of the smart home 100 and controlling the operation of the power outlet accordingly. The detailed operation principle of the power outlets and their corresponding locations will be described below with respect to FIG. 2.

The power outlets shown in FIG. 1 are of the common features of the traditional power outlets. In other words, the power outlets are coupled to a power cable 172, through which electricity is supplied to the appliances coupled to the power outlets. In addition, the power outlets are coupled to a network hub 142 through their respective communication channels, namely a first communication channel 182, a second communication channel 184 and a third communication channel 186. Depending on the configuration differences of a variety of embodiments, the communication channels 182, 184 and 186 of the smart home 100 may be implemented by using wireless communication channels, wire communication channels and any combination thereof.

As shown in FIG. 1, the network hub 142 is further coupled to a central controller 162 as well as a smart home interface terminal 152. The central controller 162 is coupled to the network hub 142 through a first bidirectional communication channel 192. In accordance with an embodiment, the first bidirectional communication channel 192 may be implemented by using suitable techniques such as wireless communication channels, wire communication channels and any combination thereof.

As shown in FIG. 1, the communication channels 192, 182, 184 and 186 are bidirectional. As a result, the central controller 162 not only receives signals from the appliances (e.g., the first appliance 102), but also sends some control commands to the power outlets (e.g., the first power outlet 122). By controlling the power outlets, the central controller 162 may further control the operation of the appliances of the smart home 100. For example, the central controller may turn off an appliance by turning off the power coupled to the power outlet, to which the appliance is connected.

The smart home interface terminal 152 is able to access the data transferred between the central controller 162 and the network hub 142 through a second bidirectional communication channel 194. In accordance with an embodiment, the second bidirectional communication channel 194 may be implemented by using wireless communication channels, wire communication channels and any combination thereof. In accordance with an embodiment, the smart home interface terminal 152 may be implemented by suitable input and output devices such as a display terminal. Throughout the description, the smart home interface terminal 152 may be alternatively referred to as the display terminal 152.

A user of the smart home is able to access the information of the appliances of the smart home 100 through the smart home interface terminal 152. As shown in FIG. 1, the smart home interface terminal 152 is not coupled to the appliances of the smart home 100 directly. Instead, there is a central controller 162 placed between the appliances and the smart home interface terminal 152. An advantageous feature of having the central controller 162 is that the central controller 162 functions as a secured center to prevent illegal attacks such as hacking, virus propagation and the like. As a result, the security and reliability of the smart home 100 can be improved. Furthermore, the central controller 162 can be configured to control more than one smart home. As such, the combination of the central controller 162 and smart homes can be determined by a user. In other words, a central controller (e.g., central controller 162) may be capable of controlling a plurality of smart homes simultaneously.

FIG. 2 illustrates a simplified diagram of a smart appliance in accordance with an embodiment. One of the appliances shown in FIG. 1 is used as an example to illustrate the detailed configuration of a smart appliance. The power plug 112 may comprise a RFID tag 222 in addition to the common features of the traditional power plugs. The RFID tag 222 may be attached to the exterior surface of the power plug 112. Alternatively, the RFID tag 222 may be embedded inside the power plug 112. In accordance with an embodiment, the RFID tag 222 may be a passive RFID tag. Alternatively, the RFID tag 222 may comprise a power source such as a battery, through which the RFID tag 222 may actively broadcast its identification information so that the reader 216 can detect it in a wide range.

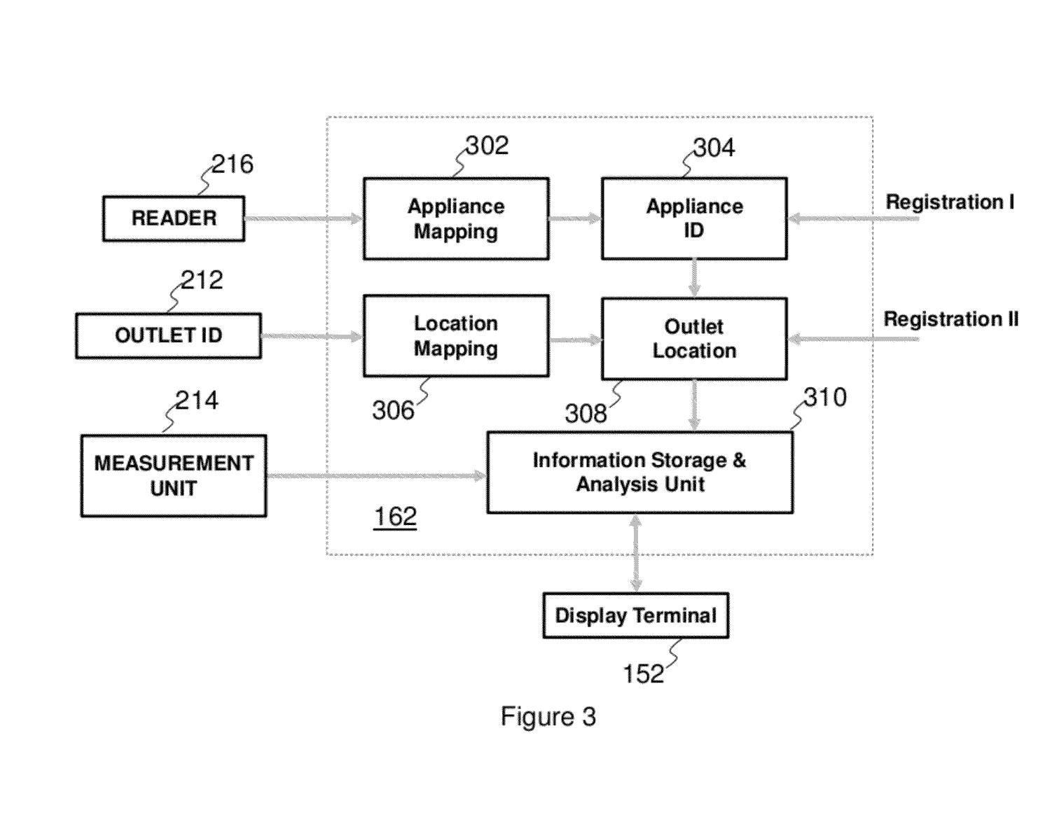

The power outlet 122 may comprise three additional features in comparison with a traditional power outlet. The power outlet 122 may comprise a RFID reader 216. The RFID reader 216 is capable of sending radio frequency signals to the power plug 112 and receiving the response from the power plug 112. In addition, the RFID reader 216 is able to transmit the received information from the power plug 112 to a central controller (not shown but illustrated in FIG. 3). The detailed transmitting process of the RFID reader 216 will be described below with respect to FIG. 3.

The power outlet 122 may further comprise a measurement unit 214. The measurement unit 214 is coupled to the power cable connected to the power outlet 122. As shown in FIG. 2, there may be a sensor 218 coupled between the power cable and the measurement unit 214. It should be noted while FIG. 2 shows the sensor 218 is a single entity, the sensor 218 may comprise various instrument transformers such as current transformers (CTs), potential transforms (PTs) and the like.

Through the sensor 218, the measurement unit 214 may obtain the operational parameters of the power outlet 122 as well as the appliance coupled to the power outlet 122. Depending on the operational parameters from the sensor 218, the central controller (not shown but illustrated in FIG. 3 is capable of retrieving a variety of electrical characteristics of the appliance coupled to the power outlet 122.

The power outlet 122 may comprise an outlet ID unit 212. The outlet ID unit 212 may comprise a unique identification number for the power outlet 122. As shown in FIG. 2, a first location 132 may comprise a location ID unit 202. When the power outlet 122 is installed in the first location 132, the mapping between the power outlet 122 and the first location 132 may be registered at the central controller (not shown but illustrated in FIG. 3). As such, the central controller 162 may acknowledge the exact location of each power outlet of the smart home 100. Even if a power outlet is removed from its original location and re-installed at a different location, through a new registration process, the central controller is able to know the current location of the power outlet.

It should be noted the registration process described above is merely an example. Various techniques may be employed to achieve this function. For example, after the power outlet 122 is installed in the first location 132, the outlet ID unit 212 may be able to communicate with the location ID unit 202 so that the mapping between the outlet ID unit 212 and the location ID unit 202 may be established as a result. Furthermore, the mapping information may be transmitted to the central controller (not shown but illustrated in FIG. 1) through either wireless channels or wire channels coupled between the power outlet 122 and the central controller.

FIG. 3 illustrates a block diagram of a central controller in accordance with an embodiment. The central controller 162 is coupled to the RFID reader 216, the output ID unit 212 and the measurement unit 214. In particular, the central controller 162 is able to receive the operation and system configuration parameters from the RFID reader 216, the output ID unit 212 and the measurement unit 214. Furthermore, the central controller 162 is coupled to a display terminal 152 through a bidirectional channel.

The central controller 162 may receive two registration signals through two registration ports (not shown), namely Registration I and Registration II. In accordance with an embodiment, Registration I is used to allow a user to register an appliance's unique ID after the appliance is first introduced into the smart home. In addition, the user may supply additional information through Registration I. The additional information may comprise the manufacture date of the appliance, the maintenance record, the operating limits of the appliance and the like. From Registration I, the central controller 162 may acknowledge the specification of a new appliance. One advantageous feature of having the specification of the new appliance is that the central controller 162 may set up different electricity rates for different types of appliances. For example, for a luxury appliance, the central controller 162 may increase its electricity rate. On the other hand, the central controller 162 may lower the electricity rate for general purpose appliances.

Registration II is used to allow a user to register a power outlet's location information after the power outlet is installed in a location. The locations suitable for installing power outlets are uniquely labeled in the smart home. When a new power outlet is installed at a particular location, the link between the location and the new power outlet is registered at the central controller 162. Subsequently, when the new power outlet is removed from the location and reinstalled at another location, the change will be updated at the central controller 162 through a new registration at Registration II.

The central controller 162 may comprise five functional units in accordance with an embodiment. An appliance mapping unit 302 is used to receive the RFID information transmitted from the RFID reader 216. As shown in FIG. 3, the appliance mapping unit 302 is coupled to an appliance ID unit 304. Through the first registration process described above, the appliance ID unit 304 is able to accumulate each appliance's ID and its corresponding system parameters. After the appliance ID unit 304 receives the signal from the appliance mapping unit 302, the appliance ID unit 304 is able to identify the corresponding system parameters.

The location mapping unit 306 is coupled to the outlet ID unit 212. Through the second registration process described above, the outlet location unit 308 is able to accumulate the information of each outlet's location. After the outlet ID unit 308 receives the signal from the location mapping unit 306, the outlet location unit 308 is able to identify the location of a particular power outlet. In addition, the outlet location 308 may receive the corresponding appliance's system parameters from the appliance ID unit 304. As a result, the outlet location unit 308 is able to link an appliance and the appliance's system parameters with a location of the smart home. As shown in FIG. 3, an information storage and analysis unit 310 receives the location and system configuration information from the outlet location unit 308. In addition, the information storage and analysis unit 310 receives the measured results from the measurement unit 214.

The information storage and analysis unit 310 is coupled to a display terminal 152 through a bidirectional channel. After receiving system configuration information and operational parameters from the outlet location unit 308 and the measurement unit 214 respectively, the information storage and analysis unit 310 is capable of performing a variety of advanced data processing programs. For example, the information storage and analysis unit 310 may calculate the power flow of the smart home based upon the location information and the measured voltage and current information.

Furthermore, the information storage and analysis unit 310 may present the power flow results to a user through the display terminal 152. The user may be able to adjust the location of various appliances or the power consumption of each appliance so that the total power consumption can be reduced as a result. It should be noted that adjusting the system configuration as well as the power consumption through a user is merely an example for illustrating the inventive aspects of various embodiments. The adjustment of the smart home can be implemented by using other suitable techniques. For example, the adjustment can be done by automatically adjusting each appliance's power consumption through a local controller attached to the appliance. Moreover, the applications based upon the operational parameters may include detecting abnormal power usage, calculating utility bills, analyzing electrical consumption habits, forecasting power load demands and the like.

In addition, the information storage and analysis unit 310 is capable of constructing a real-time model for the smart home. In accordance with an embodiment, the real-time mode for the smart home comprises a location of an appliance, an identification of the appliance, a real-time current of the appliance, a real-time voltage of the appliance, real-time power consumption of the appliance, usage of the appliance, a power supply structure of the appliance, a power flow of the appliance and the like. Moreover, the information storage and analysis unit 310 is able to provide a virtual power utilization model for the user of the smart home based upon the real-time model of the smart home. The user is able to conduct different power utilization simulation tests based upon the virtual power utilization model. One advantageous feature of having the virtual power utilization model is that the user may simulate the power usage of the smart home to predict power consumption for different smart home operation scenarios.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a location mapping unit coupled between a power outlet and an outlet location unit, wherein the location mapping unit links an outlet identification number of the power outlet with a location of a smart home;
an appliance mapping unit coupled between a reader and an appliance identification unit, wherein the appliance mapping unit links an appliance identification number of an appliance with various system parameters of the appliance;
a measurement unit configured to measure operational parameters of the appliance; and
an information storage and analysis unit coupled to the outlet location unit and the measurement unit, wherein the information storage and analysis unit is configured to:
receive the various system parameters of the appliance, the location and the operational parameters of the appliance;
analyze the various system parameters of the appliance and the operational parameters of the appliance; and
send operational information of the appliance to an input and output device.

2. The apparatus of claim 1, the appliance identification unit is coupled to a first registration port, wherein the appliance identification unit is configured to receive system parameters of the appliance.

3. The apparatus of claim 1, the outlet location unit is coupled to a second registration port, wherein the outlet location unit is configured to receive location configuration information of the smart home.

4. The apparatus of claim 1, further comprising a power plug attached to the appliance, wherein a RFID is attached to the power plug.

5. The apparatus of claim 4, wherein the measure unit comprises:
a current transformer configured to detect a current flow of the power plug; and
a potential transformer configured to detect a voltage potential of the power plug.

6. A system comprising:
an appliance comprising a power plug and a radio frequency identification tag attached to the power plug;
a power outlet comprising:
a reader configured to:
send a radio frequency signal to the radio frequency identification tag; and
receive a response from the radio frequency identification tag;
an outlet identification unit coupled to a network hub, wherein a location identification and its corresponding outlet identification are forwarded from the outlet identification unit to the network hub; and
a measurement unit coupled to a power cable attached to the power outlet, wherein the measurement unit is configured to measure operational parameters of the power outlet;
an information storage and analysis unit coupled to the reader, the outlet identification unit and the measurement unit; and
a display terminal coupled to the information storage and analysis unit.

7. The system of claim 6, wherein the information storage and analysis unit is configured to:
receive various system parameters of the appliance;
receive the operational parameters of the appliance;
analyze the various system parameters of the appliance and the operational parameters of the appliance; and
send operational information of the appliance to the display terminal.

8. The system of claim 6, wherein the display terminal is configured to:
provide an interface between a user and the information storage and analysis unit.

9. The system of claim 6, wherein:
the power outlet is coupled to the network hub through a first communication channel; and
the network hub is coupled to the information storage and analysis unit through a second communication channel.

10. The system of claim 9, wherein the appliance, the network hub, the information storage and analysis unit, the first communication channel and the second communication channel form an internet of things network.

11. The system of claim 6, wherein the information storage and analysis unit is configured to acknowledge a location change when the appliance is plugged into a different power outlet.

12. The system of claim 6, wherein the information storage and analysis unit is configured to receive voltage and current signals of the power outlet through a real-time measurement of the power outlet.

13. A method comprising:
sending a radio frequency signal to a radio frequency identification tag, wherein the radio frequency identification tag is attached to a power plug of an appliance of a smart home;
receiving a response from the radio frequency identification tag;
measuring operational parameters of a power outlet, wherein the power plug is plugged into the power outlet;
forwarding the operational parameters of the power outlet, an identification number of the power outlet, the response from the radio frequency identification tag to an information storage and analysis unit through a network hub; and
displaying a plurality of parameters of the appliance through an input and output device.

14. The method of claim 13, further comprising:
registering system parameters of the appliance through a first registration port of the information storage and analysis unit; and
registering a location of the power outlet through a second registration port of the information storage and analysis unit.

15. The method of claim 14, further comprising:
linking the system parameters of the appliance with the response from the radio frequency identification tag; and
linking the location of the power outlet with a power outlet identification number.

16. The method of claim 13, further comprising:
calculating a power flow of the smart home based upon the operational parameters of the appliance.

17. The method of claim 13, further comprising:
detecting a current flow of the power outlet through a current transformer embedded in the power outlet; and
detecting a voltage potential of the power outlet through a voltage transformer embedded in the power outlet.

18. The method of claim 13, further comprising:
assigning a first unique identification number for each appliance of the smart home;
registering the first unique identification number at the information storage and analysis unit;
assigning a second unique identification number for each power outlet location of the smart home; and
registering the second unique identification number at the information storage and analysis unit.

19. The method of claim 13, further comprising:
constructing a real-time model for the smart home at the information storage and analysis unit, wherein the real-time mode for the smart home comprises:
a location of a appliance;
an identification of the appliance;
a real-time current of the appliance;
a real-time voltage of the appliance;
real-time power consumption of the appliance;
usage of the appliance;
a power supply structure of the appliance; and
a power flow of the appliance.

20. The method of claim 19, further comprising:
providing a virtual power utilization model for a user of the smart home based upon the real-time model of the smart home, wherein the user conducts different power utilization simulation tests based upon the virtual power utilization model.
